(19) United States
(12) Patent Application Publication
(10) Pub. No.: US 2014/0278780 A1
(43) Pub. Date: Sep. 18, 2014

(54) ESTIMATION OF UNOBSERVED DEMAND

(71) Applicants: Burcu Aydin, Mountain View, CA (US); Kemal Guler, San Jose, CA (US); Enis Kayis, East Palo Alto, CA (US); Mehmet O. Sayal, Sunnyvale, CA (US)

(72) Inventors: Burcu Aydin, Mountain View, CA (US); Kemal Guler, San Jose, CA (US); Enis Kayis, East Palo Alto, CA (US); Mehmet O. Sayal, Sunnyvale, CA (US)

(21) Appl. No.: 14/354,100

(22) PCT Filed: Oct. 31, 2011
(86) PCT No.: PCT/US2011/058666

§ 371 Date: Apr. 24, 2014

(51) Int. Cl. G06Q 30/02

(52) U.S. Cl. CPC G06Q 30/0202
USPC 705/7.31

(57) ABSTRACT

A non-transitory machine-readable storage device comprising executable instructions that, when executed cause a processor to estimate a dependence vector (104), resulting in a first dependence estimate. The processor is further caused to estimate a sampling of unobserved demand (108) using the first dependence estimate to scale observed factors. The processor is further caused to output to a display device (110) information based on the first dependence estimate or the sampling.

### BACKGROUND

The use of collaborative inventory management systems between manufacturers and buyers is popular for handling the flow of goods within a supply chain system because these systems increase efficiency by reducing inventory levels and out-of-stock scenarios. The level of collaboration may differ in different settings. For example, the parties may choose to share only demand and inventory level information, or the parties may collaborate on planning, forecasting, and replenishment activities. As another example, the inventory of the buyer may be completely managed by the manufacturer. Regardless of the level of collaboration, inaccurate forecasts shared between the parties are a detriment to success. For example, the demand forecasted should accurately represent the actual demand.

### BRIEF DESCRIPTION OF THE DRAWINGS

For a detailed description of examples of the invention, reference will now be made to the accompanying drawings in which.

FIG. 1 illustrates a method of estimating unobserved demand according to at least one example; and

FIG. 2 illustrates a particular machine for estimating unobserved demand according to at least one example.

### DETAILED DESCRIPTION

In the collaborative system, inventory may be held by the buyer, and planning of future purchases may be handled collaboratively by both the buyer and the manufacturer by exchanging information in the form of forecasts of demand and supply for upcoming periods. For example, every period the buyer communicates both the actual demand for the period and forecasted demand to the manufacturer, and the buyer receives the actual availability and forecasted supply in return. The accuracy of these forecasts plays a crucial role in the success of the collaboration. The manufacturer plans its manufacturing or procuring schedule based on these figures, and the buyer makes purchasing decisions based on these figures. Also, both parties update their future buying and selling plans, and thus their forecasts, based on the feedback received from the other party. In retail settings, unsatisfied demand for each period may be lost. Unsatisfied demand is the difference between demand and supply when demand is greater than supply. However, for parties higher in the supply chain such as the manufacturer and buyer, unsatisfied demand may not be lost because demand may not be satisfied from other buyers or substitute products as is typical in retail settings. Therefore, any unsatisfied demand carries over into the demand for the next period.

The discrepancies between the forecasts and the actual supply or demand for a period result in forecast errors, especially because of a ripple effect from one period to the next in inelastic demand situations. Large forecast errors cause either shortage for the buyer or result in excess inventory holding costs for the manufacturer. For a successful collaborative relationship, parties may agree on providing the other with information to a certain degree of precision. Errors above certain levels may be penalized to attain these preset goals.

An important factor in determining forecast accuracy is data availability. The lack of actual demand data is common. Given the abstract nature of this data, the complex buying structures of larger companies, and information system shortcomings, the actual demand of the buyer is rarely captured with a high degree of accuracy. Instead, shipment information is sometimes used as a proxy for demand because this data is easily captured and quantifiable. However, use of this proxy hides inaccuracies stemming from unavailability. That is, unsatisfied demand becomes unobserved demand when shipping data is used as a proxy, and unobserved demand is difficult to measure over multiple periods. In order to increase the accuracy of capturing actual demand, this unobserved demand should be estimated.

FIG. 1 illustrates a method 100 of estimating such unobserved demand beginning at 102 and ending at 112. Initial identification of terms will be helpful for the discussion. A period may be any length of time. For example, a period may be a day, a week, a month, etc. The total number of periods is represented by N. Therefore, the period set is represented by [1, . . . , N]. Explanatory variables affecting supply or demand for each period are stored in an array represented by X. S is a vector representing shipment. S may be a vector or array indicating how many units of products shipped in a particular period or periods. A binary variable, represented by I, is 0 when supply flow is healthy and 1 when there is a supply problem (e.g., backlogging). Unobserved demand, represented by D, depends on the explanatory variables, X, and may include an unknown white noise vector, represented by E. The relationship is expressed by a vector, represented by B. B may be linear, but X may be transformed, sometimes non linearly as necessary. The unobserved demand may be expressed as:

D=X*B+E (Eq. 1)

The shipment series S carries intonation regarding unobserved and observed demand. In periods where supply flow is healthy (where Iₜ=0), the shipment is equal to demand and demand is satisfied. Other periods (where Iₜ=1) are censored, or unhealthy, because supply is not enough to satisfy demand and there is unobserved demand. Consider a time running from period n to period m, m>n, such that Iₙ₋₁=0, Iₙ=1, Iₙ₊₁=1 . . . Iₘ₋₁=1, Iₘ=1, Iₘ=1, Iₘ₊₁=0. This time represents a situation where a supply problem occurred on time n and the problem continued until time m. At time m, the problem cleared so that per m+1 is healthy again. During the censored periods, the following demand preservation statements are true:

Dₙ≧Sₙ (Eq. 2)

Dₙ₊₁+Dₙ≧Sₙ₊₁+Sₙ (Eq. 3)

Dₘ+Dₘ₋₁+ . . . +Dₙ≦Sₘ+Sₘ₋₁+ . . . +Sₙ (Eq. 4)

Equation 4 corresponds to the last period, and the inequality is reversed implying that at the end of this period all backlogs are cleared. In equations 2 and 3, the cumulative demand is more than cumulative supply, which indicates backlogging. Unobserved demand values can be determined by solving equation 1, D=X*B+E, where the demand preservation statements are true, if the B vector can be correctly estimated.

Consider the following data augmentation algorithm. Let y denote observed data, z unobserved data, and ⊖ denote a parameter that depends on y and z. The objective is to estimate ⊖ if only y is known. If z were also known, then estimation of ⊖ would be trivial. If ⊖ was precisely known, z could be estimated, Given an initial starting point estimate for ⊖, if the following two steps are applied iteratively, then the algorithm will converge to an unbiased estimate for ⊖: 1) use the current ⊖ estimate and y to generate a sample of possible z values: 2) use the z sample obtained in step 1 together with y to generate a more precise estimate of ⊖.

Applying the embodiment data augmentation algorithm, and returning to equation 1, dependence and error vectors, (B, E) correspond to the random parameter ⊖. The explanatory variable X, sometimes called observed factors, and shipment in healthy periods correspond to the observed data, y, The demand values in censored periods correspond to the unobserved demand z.

Returning to the method 100, at 104, a dependence vector, B is estimated resulting in a first dependence estimate. As noted, the first dependence estimate may be based on supply. At 108, a sampling of unobserved demand, D(1)−D(A), is estimated using the first dependence estimate to scale observed factors, X, and resulting in error vectors E. In one example, a user selects the amount of samples, A, and as such the same number of error vectors results. For example, Gibbs sampling or an acceptance/rejection method may be used. As noted, the first error estimate may simulate white noise, and the sampling may be estimated over a period when demand exceeds supply. The average of these A samples gives the first average demand sample D¹.

Some steps in method 200 may be repeated with the first sampling of unobserved demand 111 to make the estimate of unobserved demand more precise. For example, a second dependence estimate, B₂, may be determined by using a first sample from the sampling, D¹, and the observed factors, X. For example, applying an ordinary least squares algorithm may result in the second dependence at any iteration. The new estimates are expected to be more precise than the older estimates, and can be used to obtain a new sampling of unobserved demand.

An error estimate, E₁, may be determined by finding the error vector using the current average demand sample, the current dependence vector estimate and the observed factors, if a linear relationship (Eq 1) is used, third error estimate can be calculated from the equation D¹=X*B₁+E₁.

At 109, the process may be repeated until a threshold of preciseness is reached or until the difference between dependence vector estimates becomes small or under a threshold. As repeated or iterated, confidence intervals or variances of various preciseness can be generated. Also other measures may be used to decide termination of iteration, For example, B being above or below a threshold, comparing the current dependence estimate with the previous dependence estimate, may be used.

At 110, information based on the first dependence estimate, the first emir estimate, or the sampling is output to a display device. For example, the unobserved demand may be communicated to a user via a display device. As another example, the unobserved demand may be part of a report or alert that is communicated to a user or may make up a portion of another variable that is communicated to a user.

The system described above may be implemented on any particular machine or computer with sufficient processing power, memory resources, and throughput capability to handle the necessary workload placed upon the computer. FIG. 2 illustrates a particular computer system 380 suitable for implementing one or more examples disclosed herein. The computer system 380 includes a hardware processor 382 (which may be referred to as a central processor unit or CPU) that is in communication with memory devices including storage 388, and input/output (I/O) 390 devices. The processor may be implemented as one or more CPU chips.

In various examples, the storage 388 comprises a non-transitory computer readable medium storage device such as volatile memory (e.g., RAM), non-volatile storage (e.g., Flash memory, hard disk drive, CD ROM, etc.), or combinations thereof. The storage 388 comprises computer-readable instructions 384 such as software that is executed by the processor 382. One or more of the actions described herein are performed by the processor 382 during execution of the software 384.

Additionally, audio or visual alerts may be triggered upon successful completion of any action described herein, upon unsuccessful actions described herein, and upon errors. Other conditions and combinations of conditions wilt become apparent to those skilled in the art, including the combination of the conditions described above, and all such conditions and combinations are within the scope of the present disclosure.

The above discussion is meant to be illustrative of the principles and various examples of the present invention. Numerous variations and modifications will become apparent to those skilled in the art on the above disclosure is fully appreciated. It is intended that the following claims be interpreted to embrace all such variations and modifications.

What is claimed is:

1. A non -transitory storage device comprising computer-readable instructions that, when executed, cause a processor to:
estimate a dependence vector (104), resulting in a first dependence estimate;
estimate a sampling of unobserved demand (108) using the first dependence estimate to scale observed factors; and
output to a display device information (110) based on the first dependence estimate or the sampling.

2. The device of claim 1, wherein when executed, the instruction cause the processor to:
estimate the dependence vector using the sampling and the observed factors, resulting in a second dependence estimate.

3. The device of claim 2, wherein when executed, the instructions cause the processor to:
iterate estimating the dependence vector unto a threshold has been reached.

4. The device of claim 1, wherein when executed, the instructions cause the processor to estimate a second sampling of unobserved demand using the latest dependence estimate to scale the observed factors.

5. The device of claim 1, wherein estimating the sampling results in an error vector for each sample.

6. The device of claim 5, wherein error vectors are averaged resulting in an average error estimate.

7. A method, comprising,
determining, by a processor, a dependence vector (104), resulting in a first dependence estimate;
determining, by the processor, a sampling of unobserved demand (108) using the first dependence estimate to scale observed factors; and
outputting, by the processor, to a display device (110) the sampling of unobserved demand.

8. The method of claim 7, further comprising:
determining, by the processor, the dependence vector using the sampling and the observed factors, resulting in a second dependence estimate.

9. The method of claim 8, further comprising determining, by the processor, a second sampling of unobserved demand using the averaged dependence estimate to scale the observed factors.

10. The method of claim 7, wherein the first dependence estimate is based on supply.

11. The method of claim 7, wherein determining the sampling of unobserved demand comprises determining, by the processor, the sampling over a period when demand exceeds supply.

12. The method of claim 7, wherein determining the sampling of unobserved demand comprises determining, by the processor, the sampling over a period when demand is inelastic.

13. A device comprising:
a processor;
a memory coupled to the processor;
the processor to:
calculate a dependence vector (104), resulting in a first dependence estimate; and
calculate a sampling of unobserved demand (108) using the first dependence estimate to scale observed factors.

14. The device of claim 13, the processor to:
calculate the dependence vector using samples from the sampling and the observed factors, resulting in a second dependence estimate.

15. The device of claim 14, the processor to calculate a second sampling of unobserved demand using the averaged dependence estimate to scale the observed factors.
